(19) United States
(12) Patent Application Publication
(10) Pub. No.: US 2014/0056309 A1
(43) Pub. Date: Feb. 27, 2014

(54) METHOD AND APPARATUS FOR FRAME TRANSFER USING VIRTUAL BUFFER

(71) Applicant: Rahul Singh, Harrow (GB)

(72) Inventor: Rahul Singh, Harrow (GB)

(73) Assignee: NOKIA CORPORATION, Espoo (FI)

(21) Appl. No.: 13/989,654

(22) PCT Filed: Dec. 1, 2010
(86) PCT No.: PCT/IB10/55534

§ 371 Date: Jul. 19, 2013

(51) Int. Cl. H04L 12/931

(52) U.S. Cl. CPC H04L 49/70
USPC 370/401

(57) ABSTRACT

A method comprises linking a plurality of physical buffers to provide one or more virtual buffers; transferring content to the one or more virtual buffers; and transferring the content from the one or more virtual buffers through one or more buffer transfers to a first entity.

### TECHNICAL FIELD

Various embodiments relate generally to delivery of media content.

### BACKGROUND

The OpenMAX Integration Layer (IL) is an open standard developed by the Khronos Group for providing media components portability across an array of different hardware and software platforms. In accordance with OpenMAX IL, an application programming interface, the OpenMAX IL API, provides abstraction of the hardware and software architecture in the system.

The OpenMAX IL API allows a client, such as an application, to create a media processing chain by connecting together various components. Content data is typically fed into the chain at one end and sequentially processed by each component in the chain. The data is transported between components using ports and buffers.

### SUMMARY

Various aspects of example embodiments are set out in the claims.

According to a first aspect, a method comprises linking a plurality of physical buffers to provide one or more virtual buffers; transferring content to the one or more virtual buffers; and transferring the content from the one or more virtual buffers through one or more buffer transfers to a first entity.

According to a second aspect, an apparatus comprises at least one processor; and at least one memory including computer program code, the at least one memory and the computer program code configured to, with the at least one processor, cause the apparatus to perform at least the following: linking a plurality of physical butlers to provide one or more virtual buffers; transferring content to the one or more virtual buffers; and transferring the content from the one or more virtual buffers through one or more buffer transfers to a first entity.

According to a third aspect, a computer-readable medium including computer executable instructions which, when executed by a processor, cause an apparatus to perform at least the following: link a plurality of physical buffers to provide one or more virtual buffers; transfer content to the one or more virtual buffers; and transfer the content from the one or more virtual buffers through one or more buffer transfers to a first entity.

According to a fourth aspect, an apparatus comprises means for linking a plurality of physical buffers to provide one or more virtual buffers; means for transferring content to the one or more virtual buffers; and means for transferring the content from the one or more virtual buffers through one or more buffer transfers to a first entity.

According to a fifth aspect, a computer program which, when executed by a processor, causes an apparatus to perform at least the following: link a plurality of physical buffers to provide one or more virtual buffets; transfer content to the one or more virtual buffers; and transfer the content from the one or more virtual buffers through one or more butler transfers to a first entity.

### BRIEF DESCRIPTION OF THE DRAWINGS

For a more complete understanding of example embodiments, reference is now made to the following descriptions taken in connection with the accompanying drawings in which:

FIG. 1 illustrates a software landscape in accordance with the OpenMAX Integration Layer (IL) Application Programming Interface (API);

FIG. 2 illustrates an example arrangement in accordance with OpenMAX IL API;

FIG. 3 illustrates an example transfer of content in the arrangement of FIG. 2;

FIG. 4 illustrates an example transfer of content in the arrangement of FIG. 2 in accordance with an embodiment;

FIG. 5 illustrates an example transfer of content in the arrangement of FIG. 2 in accordance with another embodiment;

FIGS. 6A-D illustrate various embodiments for managing the linkage between the physical buffers and the virtual buffers;

FIG. 7 illustrates an example embodiment of a process for the use of virtual buffers;

FIG. 8 illustrates an example embodiment of a device for use with virtual buffers;

FIG. 9 is an overview diagram of a system within which various embodiments may be implemented; and

FIG. 10 is a schematic representation of the circuitry which may he included in an exemplary electronic device which may be utilized in accordance with various embodiments.

### DETAILED DESCRIPTION OF THE DRAWINGS

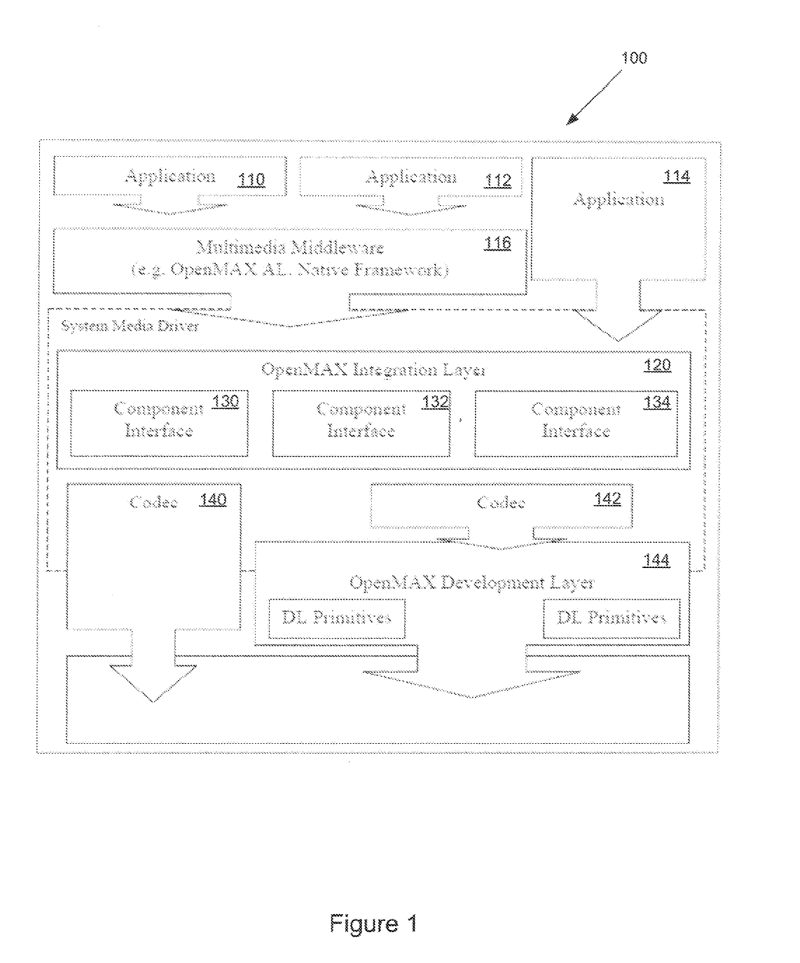

Example embodiments and their potential advantages are understood by referring to FIGS. 1-7 of the drawings.

Referring now to FIG. 1, the software landscape in accordance with the OpenMAX Integration Layer (IL) Application Programming Interface (API) is illustrated. In accordance with the OpenMAX IL API, an application layer abstracts multimedia applications 110, 112 and 114 for access by, for example, a communication device. The communication device may be any of a variety of devices, such as a mobile handset, a laptop, a personal computer (PC), a tablet device, a set-up box, a personal digital assistant (PDA) device, a media player or other communication device. For some applications, such as application 114, a user-level media framework may already exist. For other applications, such as applications 110 and 112, a multimedia middleware layer 116 is provided.

The OpenMAX IL API 120 fits below the application layer or the multimedia middleware layer. The OpenMAX IL API 120 provides an interface for components (e.g., component interfaces 130, 132, 134) and codecs 140, 142 used by the communication device. In this regard, the OpenMAX IL API 120 provides applications (e.g., applications 110, 112, 114) the ability to interface with codecs and components in a manner that is portable across operating systems.

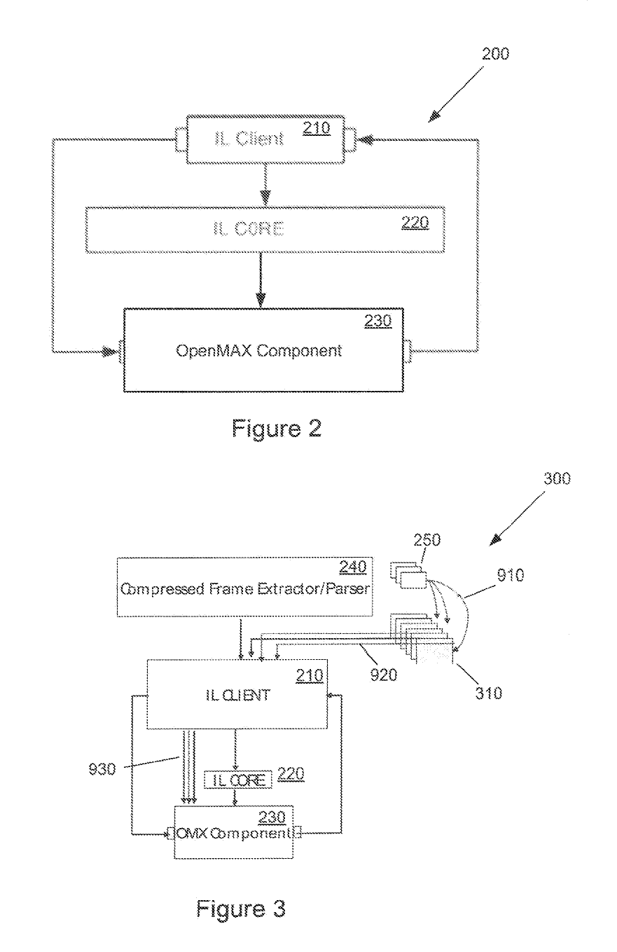

Referring now to FIG. 2, an example arrangement 200 in accordance with OpenMAX IL API is illustrated. The OpenMAX IL API includes a core API 220. The core API 220 may be used for dynamically loading and uploading components. The core API 220 allows an OpenMAX IL client 210 to communicate directly with an OpenMAX component 230, thereby eliminating overhead for high commands.

In the OpenMAX IL environment, when high-resolution compressed video frames are transferred from the IL Client 210 to the OpenMAX component 230 for decoding, the size of individual OpenMAX buffers must be large enough to accommodate the complete compressed frame. In this regard, contiguous memory allocation may be required to ensure faster operation. Because of this memory constraint, individual OpenMAX buffer size is much less than the size required for complete transfer of the compressed frame.

In this regard, the IL client 210 must perform multiple OpenMAX buffer transfers in order to transport a single complete compressed frame to the OpenMAX Component 230. The resulting increased number of OpenMAX buffer transfers can result in a decrease in the throughput of the system.

Referring now to FIG. 3, an example transfer of content in the OpenMAX IL environment is illustrated. In the illustrated example, a dedicated software component 240 manages the extraction of compressed frame from a source. A cache 250 is used to hold the complete compressed frame. This software component 240 interacts with the IL Client 210. The software component 240 and the IL Client 210 communicate through buffer transfers.

In this regard, each full compressed frame transfer to the OpenMAX Component 230 requires copying of the frame from the cache 250 to multiple OpenMAX buffers 310 (as illustrated by line 910). Multiple buffer transfers between the software component 240 and the IL client 210 (as illustrated by line 920) and the same number of buffer transfers between the IL client 210 and the OpenMAX. Component 230 (as illustrated by line 930) are needed.

The need for multiple buffer transfers increases the cache requirement in order to hold the complete compressed frame until it gets transferred to the OpenMAX Component 230. This may he due to the increased number of OpenMAX buffer transfers may delay the availability of the OpenMAX buffers 310. The cache 250 currently being used to hold the partly transferred compressed frame remains unavailable for subsequent frames.

In accordance with embodiments of the present invention, virtual buffers may he used to transfer subsequent frames.

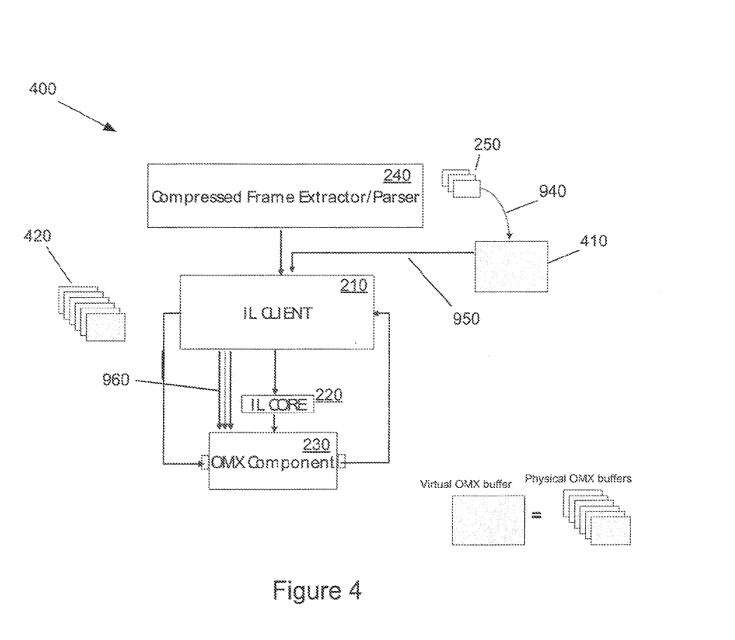

Referring now to FIG. 4, an example transfer of content in the OpenMAX IL environment in accordance with an example embodiment is illustrated. In the illustrated embodiment, the size of a compressed frame is assumed such that a plurality (n) of OpenMAX butlers would be needed to accommodate it completely. In accordance with various embodiments, the IL Client 210 uses a virtual OpenMAX buffer 410 to reduce the number of buffer transfers required. The virtual OpenMAX buffer 410 is based on the linkage of a plurality (n) of physical OpenMAX buffers, such as physical OpenMAX buffers 310 of FIG. 3.

In accordance with the illustrated embodiment, the IL Client 210 manages the virtual OpenMAX buffer 410 and its linkage to n physical OpenMAX buffers. The OpenMAX component 230 receives the physical OpenMAX buffers 420 from the IL Client 210. The physical OpenMAX buffers 420 hold the full compressed frame in parts. The linkage and mapping between the virtual buffer 410 and the physical OpenMAX buffers 420 is encapsulated inside software entity representing IL Client 210.

Thus, a frame is transferred from the cache 250 to the virtual buffer 410 in a single transfer (line 940 in FIG. 4), and a single transfer of the virtual buffer to the IL Client 210 (line 950 of FIG. 4) is used. In the illustrated embodiment, a physical buffers are linked to map to a single virtual buffer. In other embodiments, the number of virtual buffers may be greater than one but less than n, and may still provide the benefits of reduced transfer. Then, n physical buffer transfers are needed to provide the frame from the IL client 210 to the OpenMAX component 230 (line 960 of FIG. 4).

In this regard, performance is improved by making a single buffer copy and a single transfer up to the IL Client 210 level. Faster transfer results in better utilization of same cache in holding subsequent compressed frames. The performance improvement is achieved by copying the content from the cache 250 to the virtual OpenMAX buffer 410, rather than needing number of copies and transfers to physical OpenMAX buffers (e.g., buffers 310 in FIG. 3) up to the IL Client 210 level.

In transferring the frame from the cache 250 to the virtual OpenMAX buffer 410, the frame is copied to the n physical OpenMAX buffers. The virtual buffer is produced through a linking of the physical layers. The linking is mapped by the IL Client 210. In this regard, the IL Client 210 may map a starting and ending point of a portion of the frame to one of the plurality of physical buffers. This mapping is then used to perform both copy and transfer of n physical buffers as a single virtual buffer. The copy and transfer takes place between an extractor/parser (e.g., the compressed frame extractor/parser 240 of FIG. 3) and the IL Client 210. In one embodiment, the mapping is initially created by the IL Client 210 and is based on the extractor/parser 240 informing the IL Client 210 of the total size of the next full compressed frame. Further, since the size of each physical OpenMAX buffer 310 is constant and known to the IL Client 210, the IL Client 210 can easily create a linkage of a plurality (a) of physical buffers 310 to one or more virtual buffers.

The IL Client 210 maps the virtual OpenMAX buffer 410 back to n physical OpenMAX buffers 420 for transfer of the frame to the OpenMAX Component 230 through a OpenMAX buffer transfers (line 960 in FIG. 4).

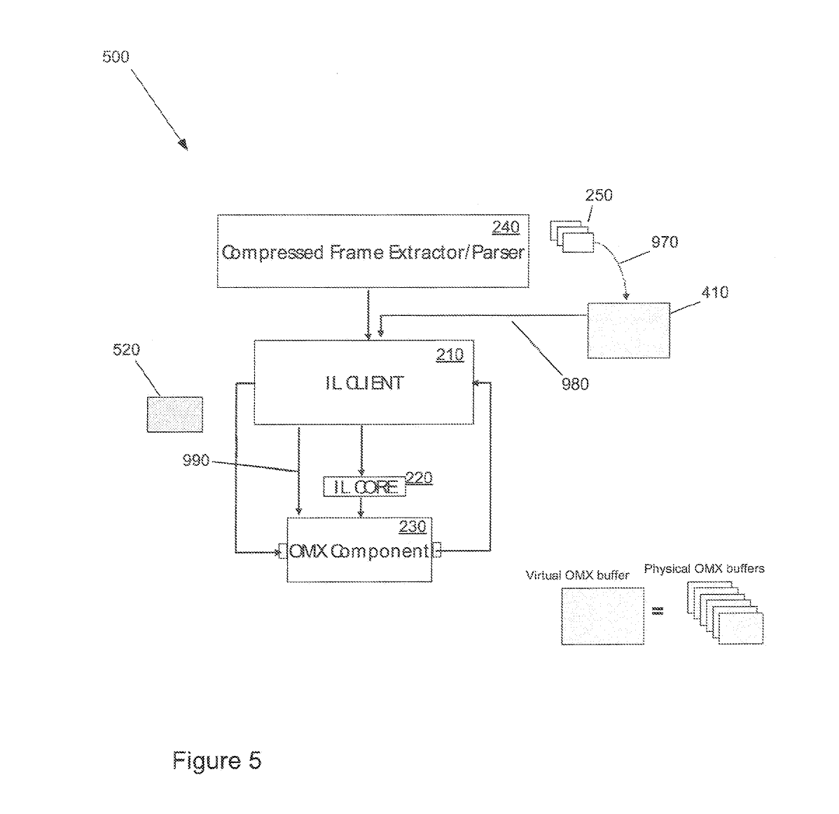

Referring now to FIG. 5, an example transfer of content in the OpenMAX IL environment in accordance with another embodiment of the present invention is illustrated. In the illustrated embodiment of FIG. 5, the size of a compressed frame is assumed such that a plurality (n) of OpenMAX buffers would be needed to accommodate it completely. In accordance with embodiments of the present invention, the IL Client 210 uses a virtual OpenMAX buffer 410 to reduce the number of buffer transfers required. As noted above, the virtual OpenMAX buffer 410 is based on the linkage of a plurality (n) of physical OpenMAX buffers.

In accordance with the illustrated embodiment of FIG. 5, the OpenMAX component 230 manages the virtual OpenMAX buffer 410 and its linkage to the plurality (n) of physical OpenMAX buffers. The IL Client 210 receives the virtual OpenMAX buffer 410, 520 from the OpenMAX Component 230. In one embodiment, the virtual OpenMAX buffer 410, 520 can hold the complete compressed frame. The linkage and mapping between virtual and physical OpenMAX buffer is encapsulated inside OpenMAX Component 230. As noted above, n physical buffers are linked to map to a single virtual buffer. In other embodiments, the number of virtual buffers may be greater than one but less than a, and may still provide the benefits of reduced transfer.

In accordance with the embodiment of FIG. 5, performance is improved by making a single buffer transfer from the IL Client 210 to the OpenMAX Component 230 (line 990 in FIG. 5). Faster transfer results in the cache 250 holding current compressed frame being locked for smaller duration. Thus, the cache 250 may be utilized for further caching of subsequent complete compressed frame. This in turn, reduces memory foot prints.

In accordance with various embodiments, a regular mechanism for allocating buffers (via OMX_UseBuffer/OMX_AllocateBuffer) may work as it currently does during Loaded to Idle State movement. Virtual OMX Buffer re-groups certain number of the actual physical buffers to cope with the situation when IL Client needs larger memory for a given frame. No dynamic memory allocation is required when component is in Idle or Executing state. Physical OMX Buffers created via OMX_UseBuffer or OMX_AllocateBuffer are merged in order to represent one virtual OMX Buffer.

In accordance with various embodiments, an OMX extension is used to enable the usage of virtual OpenMAX Buffers. In this regard, OMX_VIRTUAL_BUFFERHEADERTYPE structure is introduced to provide base address and total size of the virtual buffer. This is achieved by maintaining a list of corresponding physical OpenMAX buffers as private member variables of this structure. The IL Client 210 can request for this virtual OpenMAX buffer structure and pass total buffer size as an input. The OpenMAX Component 230 can then internally map a plurality (n) of physical OpenMAX buffers and add them as private variables to this structure for easy mapping. In some embodiments, the IL Client 210 can itself provide the linkage between virtual and physical OMX Buffer based on the data length in the cache.

The extension structure OMX_VIRTUAL_BUFFERHEADERTYPE can be defined as following:

struct OMX_VIRTUAL_BUFFERHEADERTYPE {
OMX_U32 nSize;
OMX_VERSIONTYPE nVersion;
OMX_U32 nPortIndex;
OMX_U32 nDataLength;
OMX_U32 nPhysicalOMXBufferHdrs;
OMX_U8 data[1];
}

The parameters are explained below.

“nSize” is the site of the structure including data bytes and any padding necessary to ensure the addresses of n physical OMX_BUFFERHEADERTYPE gets stored such that data [0] represents the array holding the address of first physical OMX_BUFFERHEADERTYPE and subsequently the addresses of remaining n-1 physical omx buffer headers.

“nPortIndex” is the value containing the index of the port on which this virtual buffer header will be used.

“nDataLength” represents the length of filled data in the cache. This is the size of one full frame compressed.

“nPhysicalOMXBufferHdrs” represents the number of physical OMX buffers required to accommodate the compressed frame fully. These OMX buffers will be mapped to a single OMX_VIRTUAL_BUFFERHEADERTYPE being represented by the structure.

“data[1] represents an array which holds the address of first physical OMX Buffer header OMX_BUFFERHEADERTYPE. Memory is allocated such that data [0] represents address of first physical OMX Buffer header OMX_BUFFERHEADERTYPE, data [1] represents address of second physical OMX Buffer header and data [nPhysicalOMXBufferHdrs-1] represents the address of last physical OMX Buffer header.

The relation between nDataLenth, nPhysicalOMXBufferHdrs and data [1] is related by following equation:

nDataLength≦Σ(reinterpret_cast<OMX_BUFFERHEADERTYPE*>(data[x])::nAllocLen), where x ranges from 0 to nPhysicalOMXBufferHdrs-1.

The extension index OMX_INDEX_CONFIG_VIRTUALOMXBUFFERHEADERTYPE can be used in conjugation with OMX_VIRTUAL_BUFFERHEADERTYPE via OMX_GetConfig/OMX_SetConfig method. Handling of the physical OMX_BUFFERHEADERTYPE will be the responsibility of the OMX Component if IL Client uses OMX_GetConfig to retrieve virtual Omx Buffer Header. Alternatively, handling of the physical OMX_BUFFERHEADERTYPE will be the responsibility of the IL Client if it uses OMX_SetConfig with above extended index and structure. In this case, IL Client provides this mapping beforehand by creating the virtual Omx Buffer Header. This virtual Omx Butler Header info is then passed to OMX Component by calling OMX_SetConfig, with above extended index and structure.

Whosoever handles the OMX_BUFFERHEADERTYPE (either OMX Component or IL Client) ensures that it will mark the physical omx buffer headers (represented by the virtual omx buffer header) as locked until the given virtual OMX Buffer Header is transferred to OMX Component by the IL Client (OMX_EmptyVirtualBuffer) and totally consumed (the associated callback notifying the completion).

The IL Client retrieves the virtual ( )X Buffer Header before performing step A in the figure. IL Client performs the step A in the figure by copying the contents or the cache to the physical OMX Buffers under the hood of virtual OMX Buffer. It actually starts copying to OMX_BUFFERHEADERTYPE::pBuffer provided by VIRTUAL_OMX_BUFFERHEADERTYPE::data[x] (x ranges from 0 to nPhysicalOMXBufferHdrs-1) and updates the nFilledLen for each of them.

This ensures that there is a single copy and transfer upto IL Client level at step B.

Depending upon the relation between software component (managing the extraction of compressed frame) and the software entity representing IL Client, IL Client may know the data lengths for compressed frames before the need to copy them. In such a scenario, IL Client may invoke multiple OMX_GetConfig to arrange many virtual OMX Buffer headers beforehand. Once the copy is done at step B, the cache can be used again to fill subsequent compressed frames.

When IL Client issues the above extension, this serves as a hint to OMX Component that virtual Buffers will be used for data transfers with IL Client. In this scenario, OMX_EmptyBufferDone will not be used. IL Client would rather call OMX_EmptyThisVirtualBuffer.

Macro for transferring the virtual OMX Buffer from IL Client to OMX Component will be needed. OMX_EmptyThisVirtualBuffer (COMPONENT_HANDLE, VIRTUAL_OMX_BUFFERHEADERTYPE*pVirtualBuffer) will be introduced.

Notification of consumption of the physical buffers can be done by the ususal means of OMX_CALLBACKTYPE::EmptyBufferDone. By noting the OMX_BUFFERHEADERTYPE provided through EmptyBufferDone, IL Client can make out whether or not the virtual OMX Buffer header has been fully consumed by the OMX Component. Alternative to this approach, another performance improvement can be achieved by using an extended OMX_EVENTTYPE::OMX_EventEmptyVirtualBufferDone. Compared to n times ;where n is defined by “VIRTUAL_OMX BUFFERHEADERTYPE::nPhysicalOMXBufferHdrs”) EmptyBufferDone callbacks in the first approach, this will require only 1 callback.

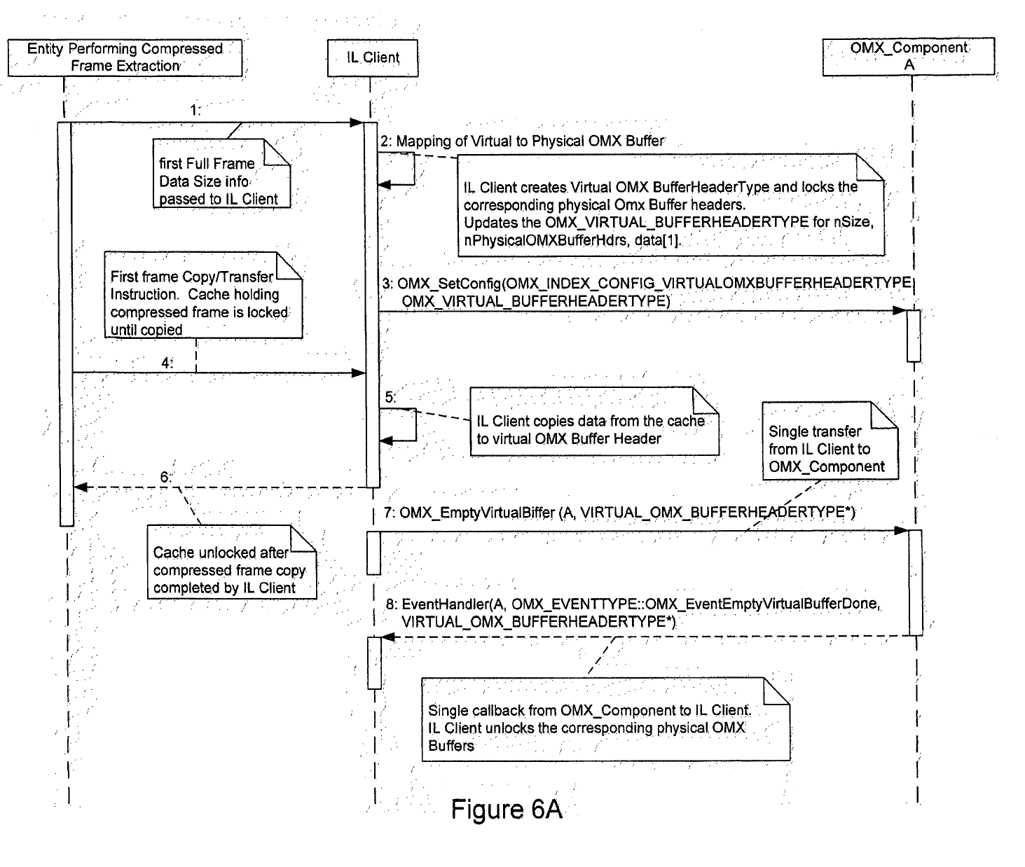

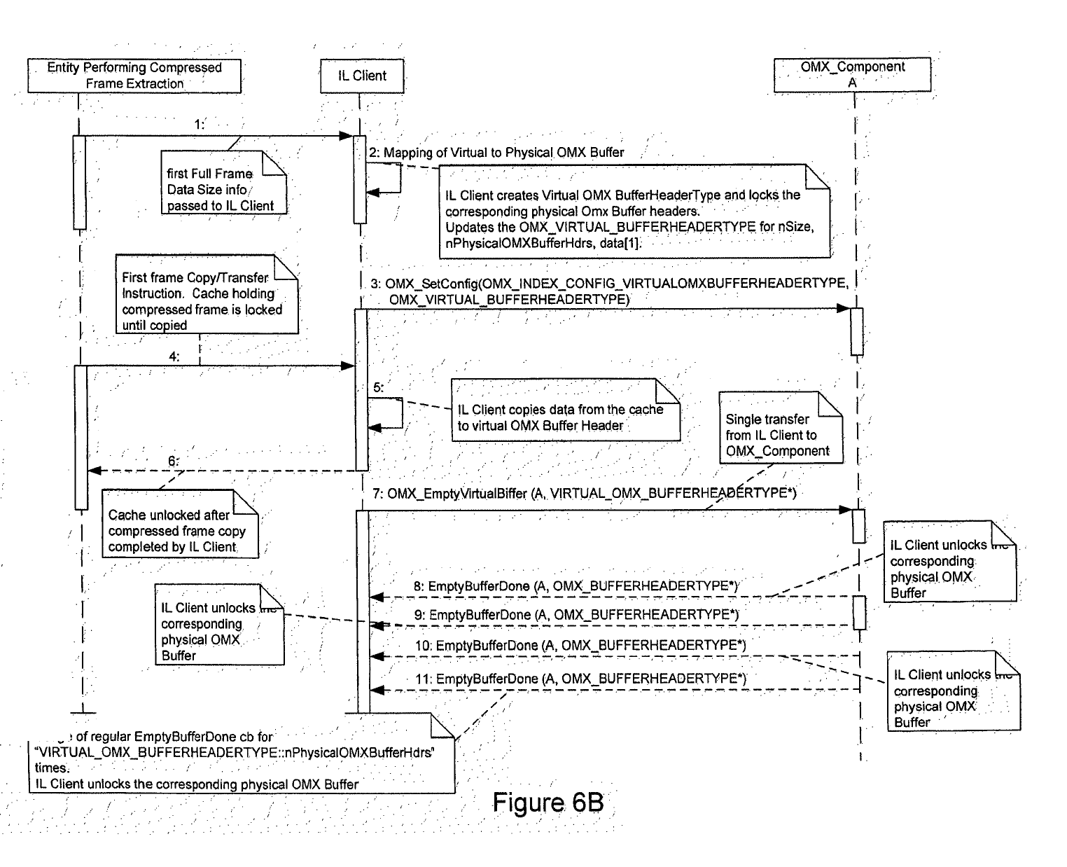

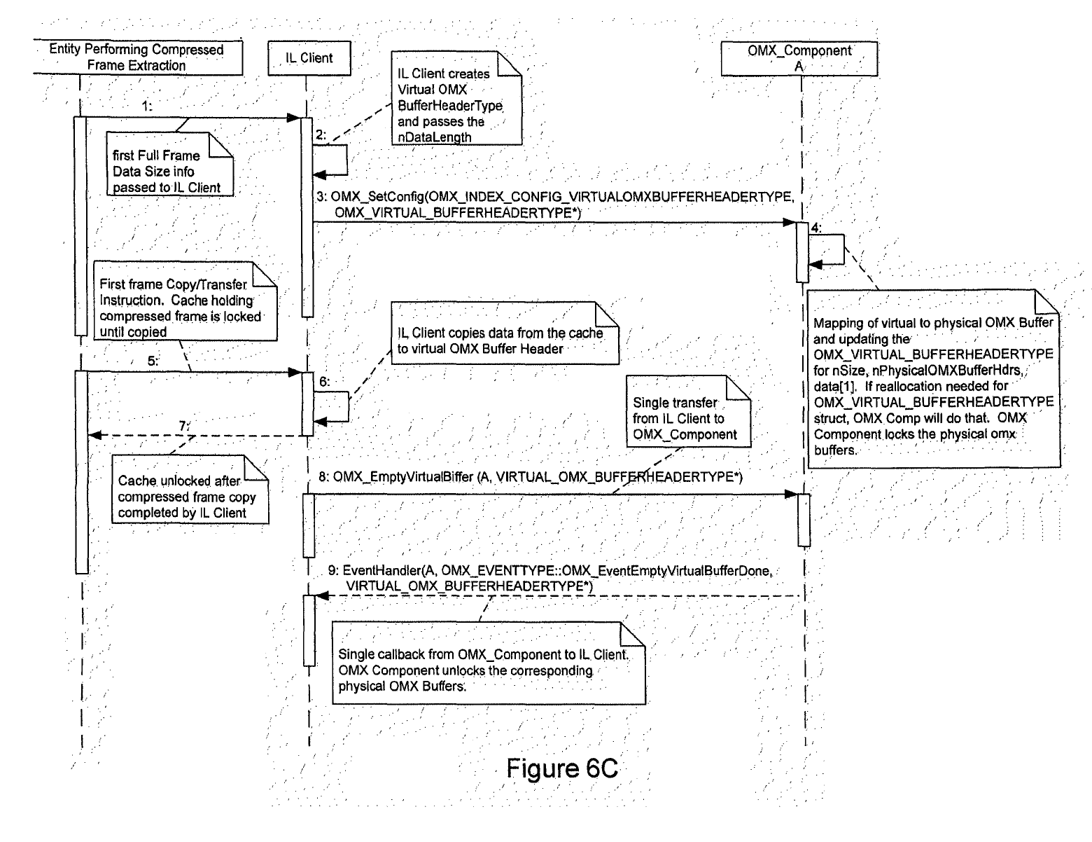

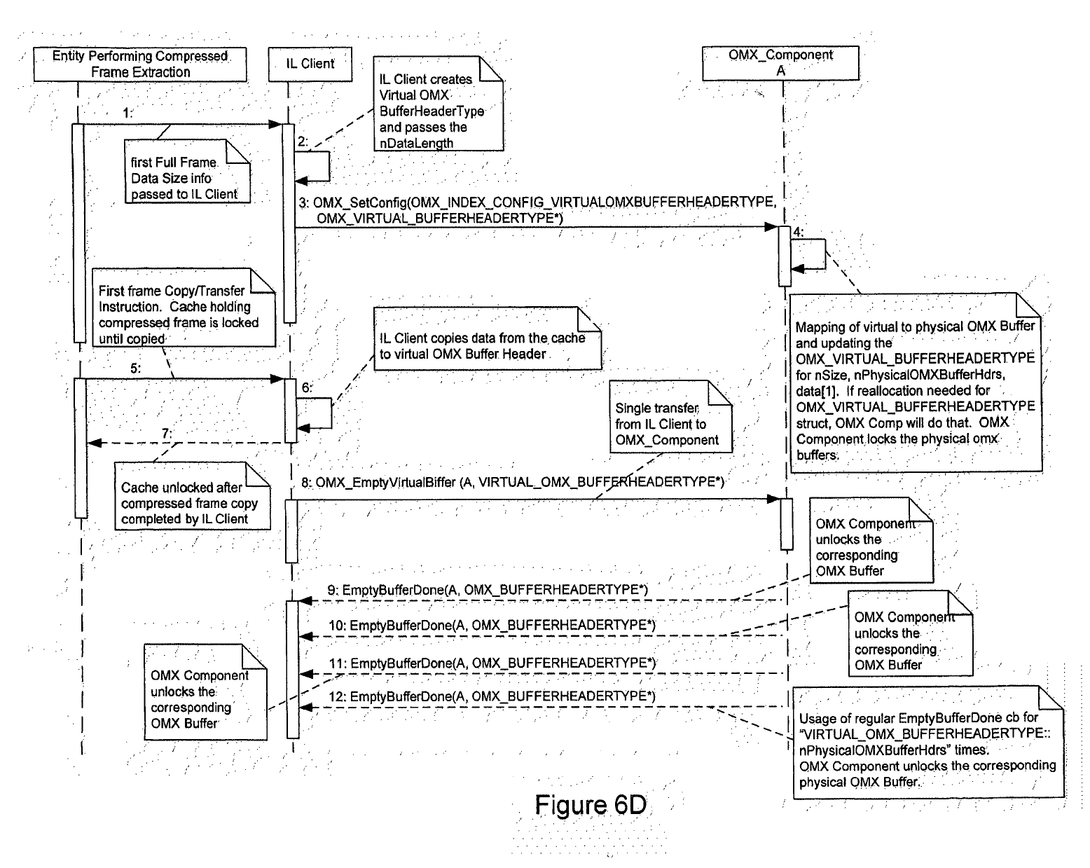

Referring now to FIGS. 6A-D, various embodiments are illustrated for managing the linkage between the physical buffers and the virtual buffers.

FIG. 6A illustrates an embodiment in which the IL Client 210 manages the linkage between virtual and physical OMX Buffers. In this embodiment, the linkage is communicated by the usage of OMX_SetConfig which informs the OpenMAX Component 230 about the virtual OMX Buffer Header. The OpenMAX Component 230, in this case, uses only one notification to inform the consumption of the full compressed data held by the OMX buffers. Thus, the physical buffers are unlocked upon complete transfer of the content from the one or more virtual buffers. Once unlocked, the physical buffers become available to receive additional content (e.g., another compressed frame). This embodiment provides efficiency in notification while using extension event for callback. In accordance with this embodiment, the individual physical OMX buffers remain locked by the IL Client 210 until the full compressed data has been consumed.

FIG. 6B illustrates an embodiment in which the IL Client 210 manages the linkage between virtual and physical OMX Buffers. In this embodiment, the linkage is communicated by the usage of OMX_SetConfig which informs the OMX Component 230 about the virtual OMX Buffer Header. In this embodiment, the OpenMAX Component 230 uses multiple notifications (EmptyBufferDone) to inform the consumption in parts (individual physical omx buffers) for the full compressed data. Thus, an individual physical buffer is unlocked upon transfer of content from the one or more virtual buffers corresponding to content in the individual physical buffer.

This embodiment ensures that the individual physical OpenMAX buffers gets unlocked as quickly as possible (e.g., just after OpenMAX component 230 consumes the portion of the full compressed frame which was represented by the given physical OpenMAX buffer provided by EmptyBufferDone).

FIG. 6C illustrates an embodiment in which the OpenMAX Component 230 manages the linkage between virtual and physical OMX Buffers. In this embodiment, the linkage is communicated by the usage of OMX_SetConfig which informs the OpenMAX Component 230 about the virtual OMX Buffer Header. In this embodiment, the OpenMAX Component 230 uses only one notification to inform the consumption of the full compressed data held by the OpenMAX buffers. This option provides efficiency in notification while using extension event for callback. Also, the individual physical OMX buffers remain locked by the IL Client 210 until the full compressed data has been consumed.

FIG. 6D illustrates an embodiment in which the OpenMAX Component 230 manages the linkage between virtual and physical OMX Buffers. In this embodiment, the linkage is communicated by the usage of OMX_GetCon fig which informs the OpenMAX Component 230 about the virtual OMX Buffer Header. In this embodiment, the OpenMAX Component 230 uses multiple notifications (EmptyBufferDone) to inform the consumption in parts (individual physical OMX buffers) for the full compressed data. This option ensures that the individual physical omx buffers gets unlocked as quickly as possible (e.g., just after OMX component consumed the portion of the full compressed frame which was represented by the given physical omx buffer provided by EmptyBufferDone).

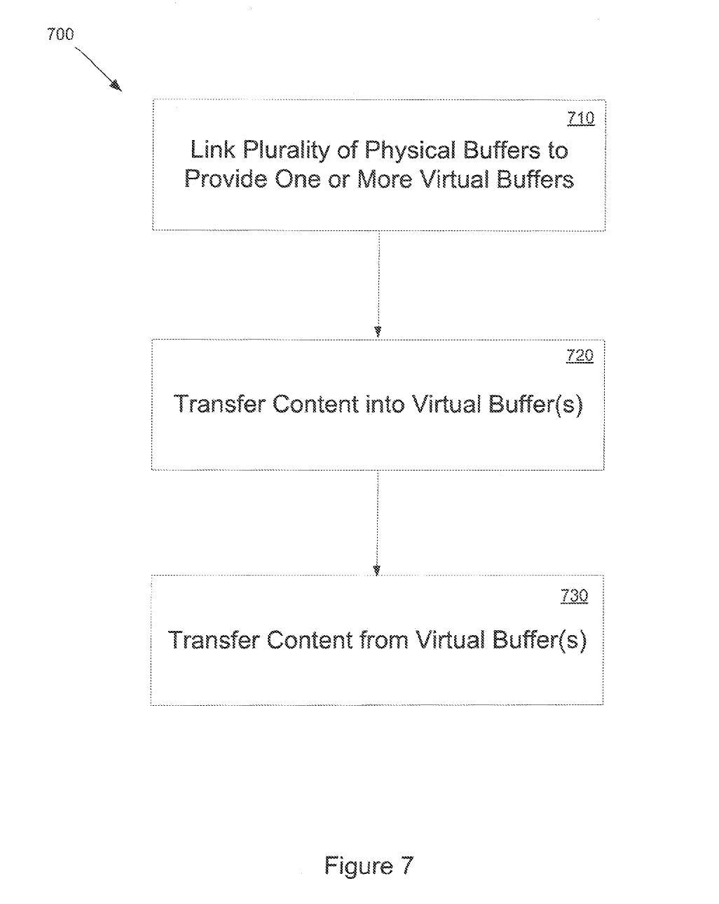

Referring now to FIG. 7, an example embodiment of a process tier the use of virtual buffers is illustrated. The process 700 includes linking a plurality of physical OMX buffers to provide one or more virtual buffers (block 710). This may be achieved by, for example, any of the embodiments described above with reference to FIGS. 6A-6D, Content may then be transferred into the one or more virtual buffers (block 720). For example, a full compressed frame may be transferred from the cache to the virtual buffer. At block 730, content may then be transferred from the virtual buffers to, for example, the IL client 210, in this regard, the content may be transferred through buffer transfers of the virtual buffer.

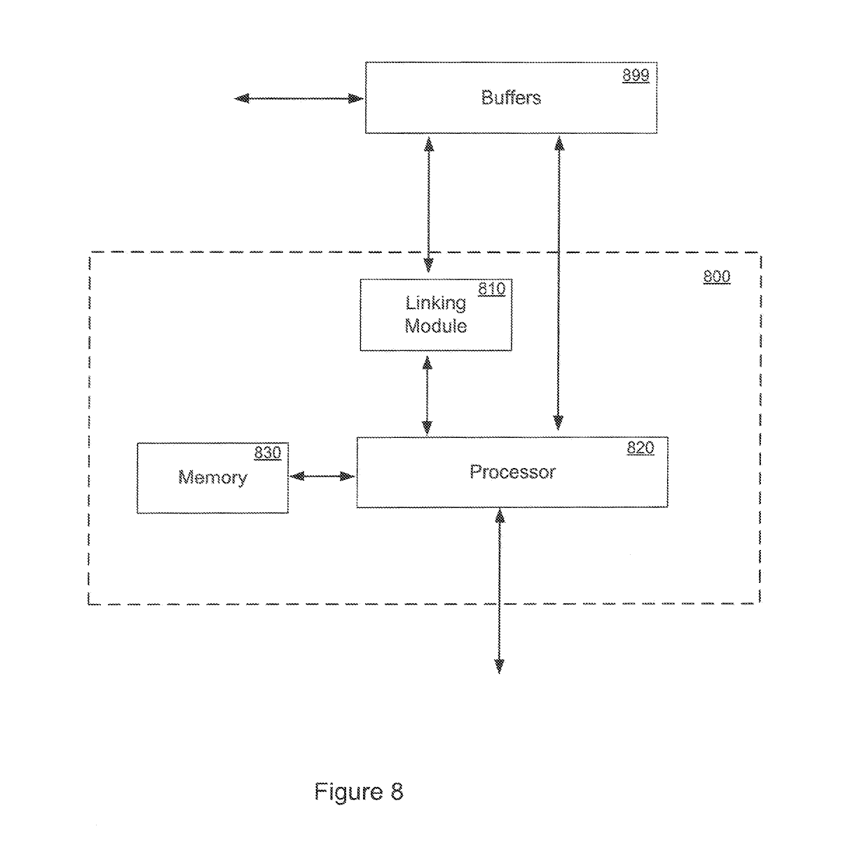

Referring now to FIG. 8, an example embodiment of a device for use with virtual buffers. The device 800 may be an IL Client or an OpenMAX component. The device 800 comprises means for linking the physical buffers to provide one or more virtual buffers. In the illustrated embodiment, the means for linking is a linking module 810 configured to communicate with the buffers 899. The means for linking may be in communication with a processor 820 configured to control operation of the means for linking. In accordance with the above-described embodiments, the processor 820 functions as a means for transferring content into the buffers (e.g., from a cache) and out of the buffers (e.g., to a OpenMAX component). The device 800 may further comprise a memory 830 (e.g., a non-transitory computer-readable medium) configured to store information. The device 800 may include further elements not illustrated in FIG. 8. For example, the device 800 may be a mobile device which includes user interface circuitry and user interface software configured to facilitate a user to control at least one function of the communication device through use of a display and to respond to user inputs. The device 800 may further include a display circuitry configured to display at least a portion of a user interface of the communication device. The display and display circuitry are configured to facilitate the user to control at least one function of the communication device.

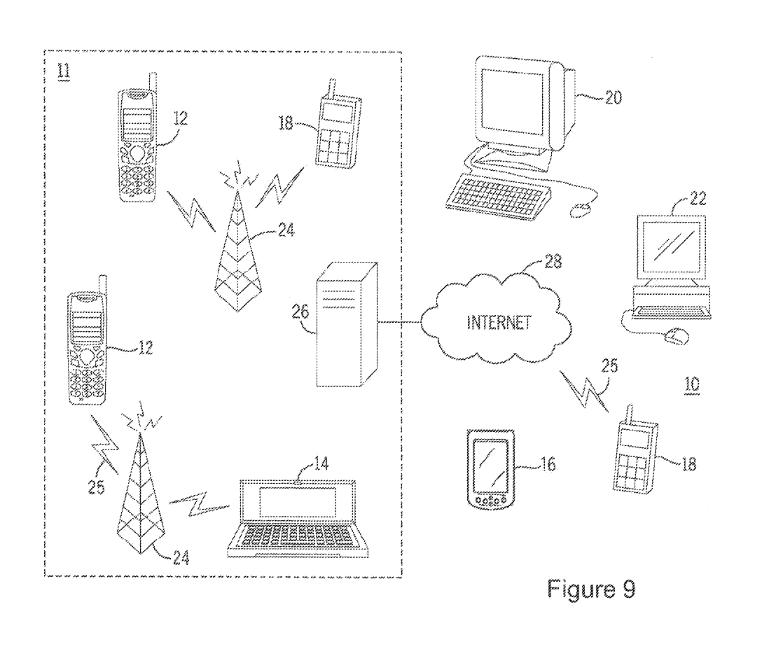

FIG. 9 shows a system 10 in which various embodiments can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 9 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (LIVID) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (CCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like,

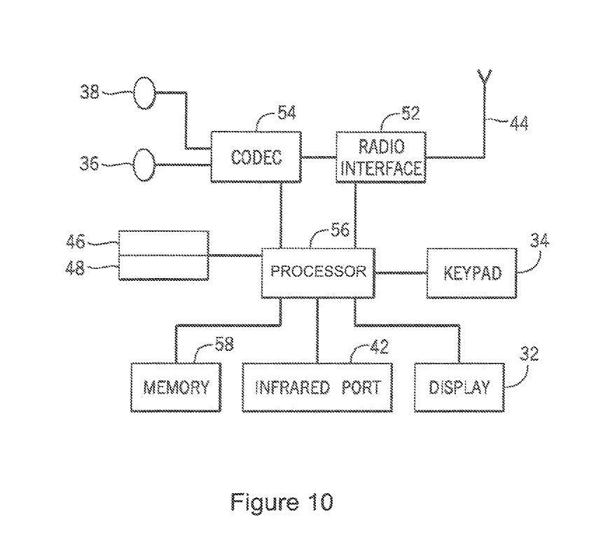

FIG. 10 shows one representative electronic device which may be used in accordance to the various embodiments of the present invention. In embodiments of the present invention, the device of FIG. 10 may be representative of a client device, a streaming server or a network device. It should be understood, however, that the scope of the present invention is not intended to be limited to one particular type of device. The electronic device of FIG. 10 may includes a housing, a display in the form of a liquid crystal display, a keypad 34, a microphone 36, an ear-piece 38, a battery, an infrared port 42, an antenna 44, a smart card 46 in the form of a UICC according to one embodiment, a card reader 48, radio interface circuitry 52, codec circuitry 54, one or more processors, such as processor 56, and one or more memories, such as memory 58. The above described components enable the electronic device to sent/receive various messages to/from other devices that may reside on a network in accordance with the various embodiments of the present invention. Individual circuits and elements of various types may be used, for example those in the Nokia range of mobile telephones.

Various embodiments described herein are described in the general context of method steps or processes, which may be implemented in one embodiment by a computer program product, embodied in a computer-readable memory, including computer-executable instructions, such as program code, executed by computers in networked environments. A computer-readable memory may include removable and non-removable storage devices including, but not limited to, Read Only Memory (ROM). Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. Various embodiments may comprise a computer-readable medium including computer executable instructions which, when executed by a processor, cause an apparatus to perform the methods and processes described herein.

Embodiments of the present invention may be implemented in software, hardware, application logic or a combination of software, hardware and application logic. The software, application logic and/or hardware may reside on a client device, a server or a network component. If desired, part of the software, application logic and/or hardware may reside on a client device, part of the software, application logic and/or hardware may reside on a server, and part of the software, application logic and/or hardware may reside on a network component. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 10. A computer-readable medium may comprise a computer-readable storage medium that may be any media or means that can contain or store the instructions for use by or in connection with an instruction execution system, apparatus, or device, such as a computer. In one embodiment, the computer-readable storage medium is a non-transitory storage medium.

If desired, the different functions discussed herein may be performed in a different order and/or concurrently With each other. Furthermore, if desired, one or mote of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-42. (canceled)

43. A method, comprising:
linking a plurality of physical buffers to provide one or more virtual buffers;
transferring content to the one or more virtual buffers; and
transferring the content from the one or more virtual buffers to a first entity.

44. The method of claim 43, wherein the plurality of physical buffers are linked in an OpenMAX integration layer (IL) environment.

45. The method of claim 43, wherein the one or more virtual buffers are transferred to the first entity through one or more buffer transfers.

46. The method of claim 43, further comprising:
mapping the content from the one or more virtual buffers to a plurality of physical buffers; and
transferring the content to a second entity.

47. The method of claim 43, wherein the content comprises a multimedia frame.

48. The method of claim 47, wherein the multimedia frame is a compressed video frame.

49. The method of claim 43, wherein the physical buffers are unlocked upon complete transfer of the content from the one or more virtual buffers.

50. The method of claim 45, wherein one or more individual physical buffers are unlocked upon transfer of content from the one or more virtual buffers corresponding to content in the one or more individual physical buffers.

51. An apparatus, comprising:
at least one processor; and
at least one memory including computer program code, the at least one memory and the computer program code configured to, with the at least one processor, cause the apparatus to perform at least:
link a plurality of physical buffers to provide one or more virtual buffers;
transfer content to the one or more virtual buffers; and
transfer the content from the one or more virtual buffers through one or more buffer transfers to a first entity.

52. The apparatus of claim 51, wherein the plurality of physical buffers are linked in an OpenMAX integration layer (IL) environment.

53. The apparatus of claim 51, wherein the one or more virtual buffers are transferred to the first entity through one or more buffer transfers.

54. The apparatus of claim 51, further wherein the at least one memory and the computer program code are further configured to, with the at least one processor, cause the apparatus to perform at least:
map the content from the one or more virtual buffers to a plurality of physical buffers; and
transfer the content to a second entity.

55. The apparatus of claim 51, wherein the content comprises a multimedia frame.

56. The apparatus of claim 55, wherein the multimedia frame is a compressed video frame.

57. The apparatus of claim 51, wherein the physical buffers are unlocked upon complete transfer of the content from the one or more virtual buffers.

58. The apparatus of claim 53, wherein one or more individual physical buffers are unlocked upon transfer of content from the one or more virtual buffers corresponding to content in the one or more individual physical buffers.

59. A computer-readable medium including computer executable instructions which, when executed by a processor, cause an apparatus to perform at least the following:
link a plurality of physical buffers to provide one or more virtual buffers:
transfer content to the one or more virtual buffers; and
transfer the content from the one or more virtual buffers through one or more buffer transfers to a first entity.

60. The computer-readable medium of claim 59, wherein the plurality of physical buffers are linked in an OpenMAX integration layer (IL) environment.

61. The A computer-readable medium of claim 59, wherein the one or more virtual buffers are transferred to the first entity through one or more buffer transfers.

62. The A computer-readable medium of claim 59, further comprising computer executable instructions which, when executed by a processor, cause an apparatus to perform at least the following:
map the content from the one or more virtual buffers to a plurality of physical buffers; and
transfer the content to a second entity.
